(19) United States
(12) Patent Application Publication
(10) Pub. No.: US 2008/0098891 A1
(43) Pub. Date: May 1, 2008

(54) TURBINE INLET AIR TREATMENT APPARATUS

(75) Inventors: Peter Feher, Suwanee, GA (US); Abbas Motakef, Duluth, GA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/552,535

(22) Filed: Oct. 25, 2006

(51) Int. Cl. B01D 47/00

(52) U.S. Cl. 95/214

(57) ABSTRACT

An inlet air treatment system. The inlet air treatment system includes a housing with more than two symmetric sides. Each of the sides includes a number of air filters and a number of spray arrays. A central air deflector is positioned within the housing.

### TECHNICAL FIELD

The present application relates generally to gas turbine engines and more particularly relates to a polar-symmetric combustion turbine inlet air treatment apparatus.

### BACKGROUND OF THE INVENTION

Air entering a turbine compressor and similar devices should be filtered before compression or other use. Impure air laden with dust particles, salt and other contaminants may damage the compressor blades and other types of power plant equipment via corrosion and/or erosion. Such damage may reduce the life expectancy and the performance of the equipment. To avoid this problem, the inlet air generally passes through a series of air filters to remove the contaminants. Such air filters generally are located at an elevated height so as to minimize the entry of ground contaminants. These known filtration systems, however, may be complicated and costly.

Conventional inlet air filters generally have air velocity restriction therethrough so as to maintain filtration and cooling efficiency. These restrictions, however, may limit the amount of air that can be filtered. Known air filters also may be clogged by environmental conditions such as rain and snow. Such clogging may reduce filtration and cooling efficiency while increasing the overall pressure drop. Inlet air pressure loss also can result in the loss of power output to the turbine as a whole.

The performance of the turbine also may be sensitive to the inlet air temperature. For example, the power output of the turbine is inversely proportional to the air temperature. The turbine thus can lose output in hot ambient conditions. Increased ambient temperatures also are detrimental to the efficiency of the turbine as a whole.

There is a desire, therefore, for an improved turbine inlet air treatment system. Such an improved air treatment system preferably would provide adequate filtering while having a minimum pressure loss. Specifically, such an air treatment system would increase the output of the turbine system as a whole and increase overall efficiency. Such an air treatment system would be particularly suitable for hot, humid and contaminated ambient conditions.

### SUMMARY OF THE INVENTION

The present application thus describes an inlet air treatment system. The inlet air treatment system includes a housing with more than two symmetric sides. Each of the sides includes a number of air filters and a number of spray arrays. A central air deflector is positioned within the housing.

The present application further describes a method of treating inlet air. The method may include the steps of passing the inlet air through a number of inlet sides, filtering the air through each of the number of sides, passing the air through a number of spray arrays on each of the number of sides, and uniformity diverting the inlet air in a symmetric fashion. The diverting step may include diverting the inlet air in a polar radial direction.

The present application further describes an inlet air treatment system. The inlet air treatment system may include a housing with six (6) symmetric sides. Each side of the housing may include a number of air filters and a number of spray arrays. The housing also includes a central air deflector with six (6) sides.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic side view of a turbine inlet air treatment system as is described herein.

FIG. 2 is a schematic top view of the air treatment system of FIG. 1.

### DETAILED DESCRIPTION

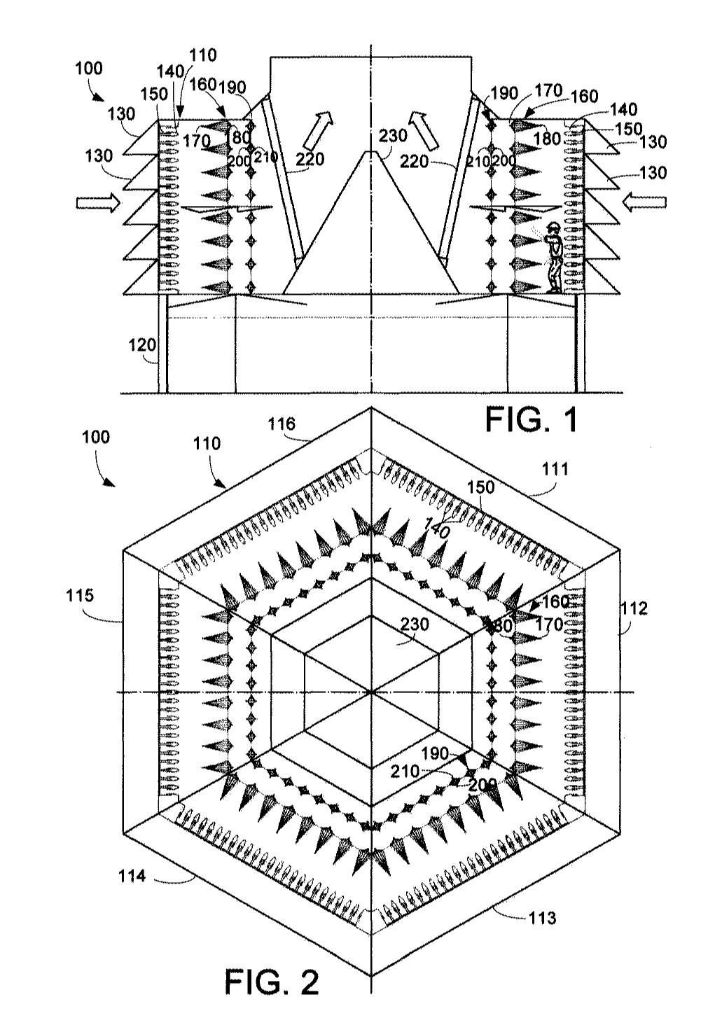

Referring now to the drawings, in which like numerals indicate like elements throughout the several views, FIGS. 1 and 2 show schematic views of a turbine inlet air treatment system 100 as is described herein. As described above, the turbine inlet air treatment system 100 may be positioned upstream of a compressor or other type of turbine component.

The air treatment system 100 includes a housing 110. The housing 110 may be made out of any type of conventional material so as to mount the components described below therein. The housing 110 may have a number of structural supports 120 such that the system 100 may be positioned at any desired height. The structural supports 120 also may be made out of any conventional type of material. As is shown, the housing 110 has a symmetric hexagonal configuration with first side 111, second side 112, third side 113, fourth side 114, fifth side 115, and sixth side 116. Similar types of symmetric and near symmetric configurations may be used herein. Likewise, the number of sides may be varied as well.

Each face of the housing 110 may have a louver or a number of louvers 130. The louvers 130 may be opened and closed as desired depending upon ambient weather conditions. The louvers 130 may have any type of conventional size and shape and may be made from any type of conventional materials.

Each face of the housing 110 also may have a number of spin-tube filters 140 positioned downstream of the louvers 130. The spin-tube filters 40 include an inner tube 150. Dirty air enters the inner tube 150 such that the contaminants are separated from the air stream by centrifugal force. The contaminants then may be removed by suction through a bleed air duct (not shown) or a similar type of structure. The suction may be provided by a blower with about ten percent (10%) of the inlet airflow. Other types of conventional air filtering devices also may be used herein.

Positioned downstream of the spin-tube filters 140 may be a first spray array 160. The first spray array 160 includes a number of spray nozzle pairs, a low cone angle nozzle 170 and a high cone angle nozzle 180. The low cone angle nozzle 170 has a higher water pressure and velocity as compared to the high cone angle nozzle 180. The low cone angle nozzle 170 thus increases the pressure of the inlet air by a venturi effect. The spray pattern creates a water curtain effect so as to both chill the inlet air and capture contaminants therein. Any number of nozzles 170, 180 may be used herein. Other types of spray patterns may be used herein.

The inlet air treatment system 100 also may include a second spray array 190. The second spray array also may include a number of spray nozzle pairs, a first nozzle 200 and a second nozzle 210. In this example, both nozzles 200, 210 may produce a uniform spray pattern. In this case, an inverted double cone spray pattern. Other types of spray patterns may be used herein. Any number of spray nozzle 200, 210 may be used herein.

The spray arrays 160, 190 may include a number of water storage tanks, water treatment devices, and water chillers associated therewith. These spray array components may be positioned within the housing 110 as may be convenient. Additional spray arrays may be used herein.

A number of drift eliminators 220 may be positioned downstream of the spray arrays 160, 190. The drift eliminators 220 prevent water carryover into the compressor and/or into other types of turbine components. The drift eliminators 220 may be of conventional design. Any number of drift eliminators 220 may be used herein.

The inlet air treatment system 100 also may include a central deflector 230. As is shown, the conical, multi-sided shape acts to deflect the inlet air uniformly upward towards the turbine components. The central deflector 230 may have a face for each of the sides 111-116 of the housing 110. Similar shapes may be used herein so as to deflect uniformly the airflow.

In use, inlet air passes through the louvers 130 and the spintube filters 140 along each face of the air treatment system 100. Contaminants within the inlet air are removed via the centrifugal effect of the inner tube 150 or otherwise.

The inlet air then passes through the first and second spray arrays 160, 190. Each spray array 160, 190 creates a continuous, chilled water spray curtain. The chilled water lowers the air temperature of the air therethrough while capturing and/or dissolving dust, salt, and other contaminants. The use of the chilled water thus increases air density as well as the air mass and the flow rate entering the combustor or otherwise. Such an increase provides higher power output with an increased overall thermal efficiency. The spray arrays 160, 190 also reduce humidity in the air in the form of condensation in all but the driest ambient conditions. The spray arrays 160, 190 likewise increase the pressure of the inlet air so as to provide an air charging effect.

Inlet air then passes through each of the drift eliminators 220 and is uniformly directed upwards via the central deflector 230 or by a similar type of structure. Specifically, the airflow is uniformly symmetric, polar radial, and upward turning.

The inlet air treatment system 100 thus provides a high face to volume ratio for the inlet air treatment process. The high face to volume (and/or face to weight ratio) is assured by the polar radial airflow pattern. This radial airflow provides a gradual increase of velocity while the use of the central deflector 230 provides low resistance. The segmented configuration of the system 100 as a whole also allows modularization. This modular arrangement facilitates transportation and reduces the time and complexity of field installations. The segments of the system 100 can be easily prefabricated.

The system 100 thus is ideal for marine, near shore, dusty, and/or polluted ambient conditions. The system 100 also is cost effective because of its low weight, adaptability for module prefabrication, ease of transportation, and ease of field installation.

It should be apparent that the foregoing relates only to the preferred embodiments of the present application and that numerous changes and modifications may be herein by one of ordinary skill in the art without departing from the general spirit and scope of the invention as defined by the following claims and the equivalents thereof.

I claim:

1. An inlet air treatment system, comprising:
a housing;
the housing comprising a plurality of more than two symmetric sides;
each side comprising a plurality of air filters;
each side comprising a plurality of spray arrays; and
a central air deflector.

2. The inlet air treatment system of claim 1, wherein the housing comprises six (6) sides.

3. The inlet air treatment system of claim 1, wherein each side comprises a plurality of louvers.

4. The inlet air treatment system of claim 1, wherein the plurality of air filters comprises a plurality of spin-tube filters.

5. The inlet air treatment system of claim 1, wherein the plurality of spray arrays comprises a plurality of spray nozzle pairs.

6. The inlet air treatment system of claim 5, wherein the plurality of spray nozzle pairs comprises a low cone angle nozzle and a high cone angle nozzle.

7. The inlet air treatment system of claim 5, wherein the plurality of spray nozzle pairs comprises an inverted double cone spray pattern.

8. The inlet air treatment system of claim 1, wherein each side comprises a drift eliminator.

9. The inlet air treatment system of claim 1, wherein the central air deflector comprises six (6) sides.

10. The inlet air treatment system of claim 1, wherein the central air deflector comprises a conical shape.

11. A method of treating inlet air, comprising:
passing the inlet air through a plurality of inlet sides;
filtering the air through each of the plurality of sides;
passing the air through a plurality of spray arrays on each of the plurality of sides; and
uniformity diverting the inlet air in a symmetric fashion.

12. The method of treating inlet air of claim 11, wherein the diverting step comprises diverting the inlet air in a polar radial direction.

13. An inlet air treatment system, comprising:
a housing with six (6) symmetric sides;
wherein each side of the housing comprises a plurality of air filters;
wherein each side of the housing comprises a plurality of spray arrays; and
a central air deflector;
wherein the central air deflector comprises six (6) sides.

14. The inlet air treatment system of claim 13, wherein each side comprises a plurality of louvers.

15. The inlet air treatment system of claim 13, wherein the plurality of air filters comprises a plurality of spin-tube filters.

16. The inlet air treatment system of claim 13, wherein the plurality of spray arrays comprises a plurality of spray nozzle pairs.

17. The inlet air treatment system of claim 16, wherein the plurality of spray nozzle pairs comprises a low cone angle nozzle and a cone angle nozzle.

18. The inlet air treatment system of claim 16, wherein the plurality of spray nozzle pairs comprises an inverted double cone spray pattern.

19. The inlet air treatment system of claim 13, wherein each side comprises a drift eliminator.

20. The inlet air treatment system of claim 13, wherein the central air deflector comprises a conical shape.
